(19) United States
(12) Patent Application Publication
(10) Pub. No.: US 2015/0314248 A1
(43) Pub. Date: Nov. 5, 2015

(54) MICROBUBBLE SYSTEM FOR TUBS

(71) Applicant: C.G. AIR SYSTEMES INC., Sainte-Marguerite de Dorchester (CA)

(72) Inventors: Miguel Castellote, Ste-Marguerite-de-Dorchester (CA); Jonathan Castellote-Ciechanowski, Ste-Marguerite-de-Dorchester (CA)

(21) Appl. No.: 14/702,089

(22) Filed: May 1, 2015

Related U.S. Application Data
(60) Provisional application No. 61/987,202, filed on May 1, 2014.

(51) Int. Cl. B01F 3/04; A61H 33/02; B01F 5/04

(52) U.S. Cl. CPC B01F 3/04113; B01F 3/0451; B01F 5/0408; A61H 33/02; B01F 2003/04943; B01F 2003/04879; B01F 2215/0052

(57) ABSTRACT

A microbubble system comprises a pipe network defining an inner passage for flow of fluids in a longitudinal direction, the pipe network adapted to receive a fluid and having an outlet connected to a tub for outputting the fluid into the tub. A pump in the pipe network induces a flow of the fluid into the tub. A gas intake in the pipe network or in the pump configured for inletting gas into the flow of the at least one fluid into the tub. A reduction member is transversely positioned inside the inner passage to block same, the reduction member downstream of the pump, the reduction member defining a plurality of longitudinally oriented passages each having a microbubble-size throat.

### CROSS-REFERENCE TO RELATED APPLICATION

The present application claims priority on U.S. Provisional Patent Application No. 61/987,202, filed in May 1, 2014, the contents of which are incorporated herein by reference.

### TECHNICAL FIELD

The present application relates to fluid injection systems for tubs.

### BACKGROUND OF THE ART

Tubs are well known for their primary use, namely a washroom installation in which a user person washes and bathes. Tubs have, however, evolved to add pleasure and comfort to practicality, and are found in many forms, such as bathtubs, spas and whirlpools.

Massage systems of various configurations have been provided to inject fluids, such as air or water, into the liquid of the tub, so as to procure a massaging effect for the occupant of the tub. One particular type of air injection system is referred to as a microbubble technology. Microbubble technology refers to the injection of gas bubbles in the water, which gas bubbles are micro-sized. For example, microbubbles are defined as being smaller than one millimetre (0.039 in) in diameter, but larger than one micrometre (3.9×10⁻⁵ in). Due to their size, microbubbles may in some instances penetrate skin pores, to exfoliate the skin and remove toxins, among other benefits. Microbubble technology exposes the bather to oxygen-rich water. It however remains a challenge to produce such microbubbles and equipment typically used for such purpose is complex.

For sterilization purposes, when a gas with bactericidal activity such as ozone is used, the local impact and heat generated when the bubble breaks also improve the effect of sterilization. Polluting substances rise to the surface and are decomposed due to the microbubbles, thereby helping to cleanse the water.

### SUMMARY

It is an aim of the present disclosure to provide a microbubble system that addresses issues associated with the prior art.

Therefore, in accordance with the present disclosure, there is provided a microbubble device for creating microbubbles in a tub, the microbubble device comprising: at least one pipe section defining an inner passage for flow of fluids in a longitudinal direction; at least a first mixing member transversely positioned inside the inner passage to block same, the first mixing member defining at least one passage longitudinally oriented and adapted to be below a top liquid surface circulating in the inner passage, the at least one passage being larger than microbubbles; a reduction member transversely positioned inside the inner passage to block same, the reduction member spaced apart and downstream of the first mixing member, the reduction member defining a plurality of longitudinally oriented passages each having a microbubble-size throat.

Further in accordance with the present disclosure, there is provided a microbubble system comprising: at least one pipe network defining an inner passage for flow of fluids in a longitudinal direction, the pipe network adapted to receive at least one fluid and having an outlet connected to a tub for outputting the at least one fluid into the tub; a pump in the pipe network for inducing a flow of the at least one fluid into the tub; at least one gas intake in the pipe network or in the pump configured for inletting gas into the flow of the at least one fluid into the tub; and a reduction member transversely positioned inside the inner passage to block same, the reduction member downstream of the pump, the reduction member defining a plurality of longitudinally oriented passages each having a microbubble-size throat.

### DESCRIPTION OF THE DRAWINGS

FIG. 1 is a schematic view of an assembly of a tub and of a microbubble system in accordance with the present disclosure;

FIG. 2 is a perspective view of an embodiment of the assembly of the tub and the microbubble system of FIG. 1;

FIG. 3 is a partially sectioned longitudinal view of a filtering assembly of the microbubble system of FIG. 1;

FIG. 4A is an assembly view of a venturi unit of the microbubble system of FIG. 1;

FIG. 4B is an assembly view of the venturi unit with gas injection unit of the microbubble system of FIG. 1;

FIG. 5 is an exploded view of a microbubble device of the microbubble system of FIG. 1;

FIG. 6 is an enlarged view of disks of the microbubble device of FIG. 5;

FIG. 7 is a perspective view of a converging disk of the microbubble device of FIG. 5;

FIG. 8 is a perspective view of an aerator disk of the microbubble device of FIG. 5;

FIG. 9A is a perspective view of a reduction disk of the microbubble device of FIG. 5;

FIG. 9B is a sectional view of the reduction disk of the microbubble device of FIG. 5;

FIG. 10A is a perspective view of an embodiment of a vent unit of the microbubble system of FIG. 1; and

FIG. 10B is a perspective view of another embodiment of a vent unit of the microbubble system of FIG. 1.

### DETAILED DESCRIPTION

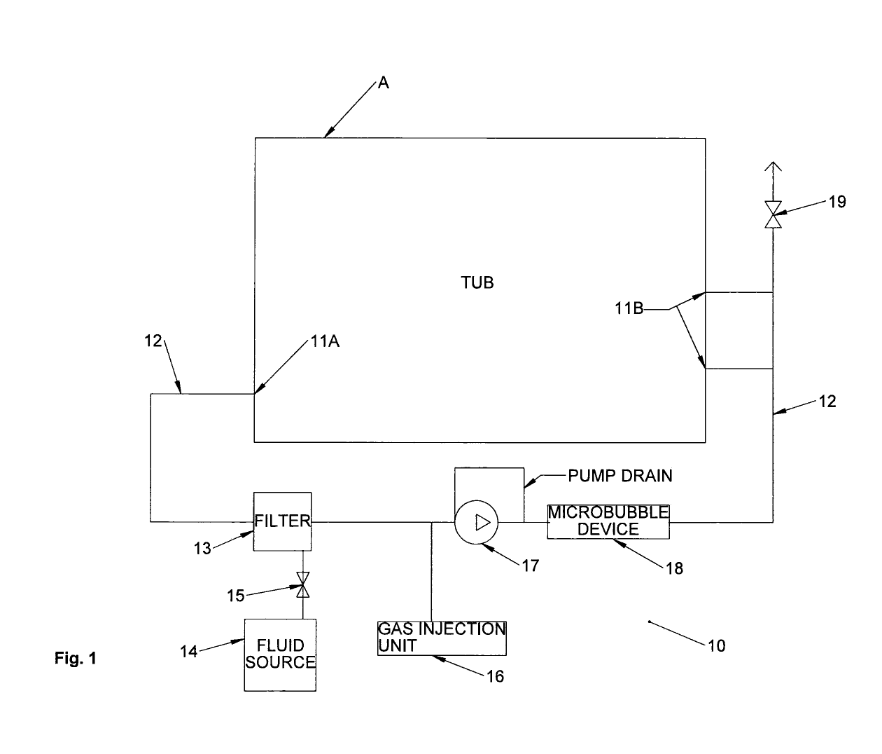

Referring to the drawings and, more particularly, to FIG. 1, there is illustrated at 10 a microbubble system used in assembly with a tub A. The microbubble system 10 is configured to operate a microbubble-producing cycle, in which a flow of microbubble-rich liquid is injected in the tub A, e.g., with gas bubbles smaller than one millimetre (0.039 in) in diameter, but larger than one micrometre (3.9×10⁻⁵ in). The tub A is any appropriate type of tub having a bathing cavity conceived to receive therein a liquid such as water. The tub A may be a bathtub, a whirlpool, a spa, among many other possibilities and names. The tub typically comprises a wall having an exposed surface forming the bathing cavity and an undersurface, the latter referred to as a hidden surface when the tub A is embedded in its surroundings. Numerous components of the microbubble system 10 are concealed under the tub and thus not visible, unless indicated otherwise.

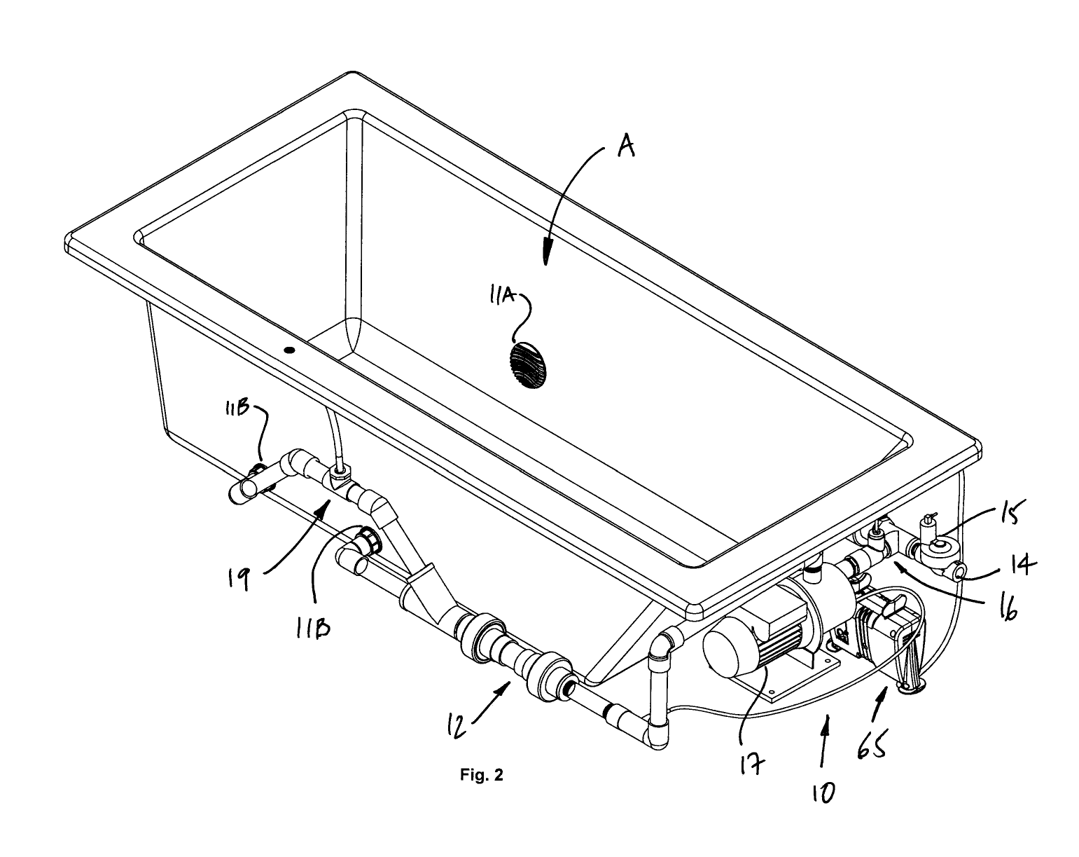

Referring to FIGS. 1 and 2, the microbubble system 10 is shown in a configuration in which liquid from the tub A is collected, subjected to the microbubble-producing cycle, and reinjected in the tub A in a microbubble-rich state. The microbubble system 10 has an inlet(s) 11A and one or more outlets 11B, which are defined through the tub wall and are thus visible in the inner cavity of the tub A. The inlet 11A is used to the collect liquid from the tub A to expose the liquid to the microbubble-producing cycle, while the outlet(s) 11B returns the liquid with microbubbles in the liquid of the tub A. Another component that may be visible is an interface of an electronic controller unit of the microbubble system 10. As a few components of the microbubble system 10 are electrically powered, an electronic controller unit featuring a processor may be connected to all operable components to operate the microbubble system 10 in producing microbubbles in the liquid of the tub. For simplicity, the electronic controller unit is not shown in the figures, but is typically provided with a keypad accessible to the user to control the operation of the microbubble system 10. It is also considered to use wireless technology and smart devices to operate the microbubble system 10.

Still referring to FIG. 1, the inlet(s) 11A and outlets 11B are shown interconnected by a plurality of components through a piping network 12. The piping network 12 is constituted of various pipes, including straight pipe sections, elbows, T-pipes, etc. During the microbubble-producing cycle, the liquid flows from the inlet 11A to the outlets 11B, in what is referred to a normal flow direction.

Referring to FIGS. 1 and 2, a filtering unit is provided in the pipe network 12 downstream of the inlet 11A. The filtering unit comprises a filter 13, a fluid source 14 and a valve 15. The filtering unit is an upstream component of the microbubble system 10 that will prevent larger residue (e.g., dirt particles, organic components such hair, etc) from reaching downstream components of the microbubble system 10.

A venturi unit 16 is downstream of the filtering unit and allows gas (e.g., air, oxygen, ozone or mixtures thereof) into the liquid stream of the microbubble system 10, which gas saturates the water of the pipe network 12 to create the microbubbles. The venturi unit 16 may or may not be working in conjunction with a specific gas injection unit (e.g., O₃) and uses the pump water suction speed to draw and mix gas into the water stream, by venturi effect. A pump 17 (illustrated with a drain) is downstream of the venturi unit 16 and induces fluid flow in the pipe network 12, from the inlet 11A to the outlets 11B. In the illustrated embodiment, the pipe network 12 will therefore source its liquid from the tub A to reinject same with microbubbles through the outlets 11B.

A microbubble device 18 produces the microbubbles with the water circulating in the pipe network 12 with the gas injected by the venturi unit 16. The pressure resulting from the action of the pump 17 will contribute to the creation of microbubbles by the microbubble device 18, in forcing the liquid/gas mixture through the microbubble device 18. A vent unit 19 may also be provided in the microbubble system 10 and is typically downstream of the venturi unit 16 to exhaust any excess gases circulating in the network 12.

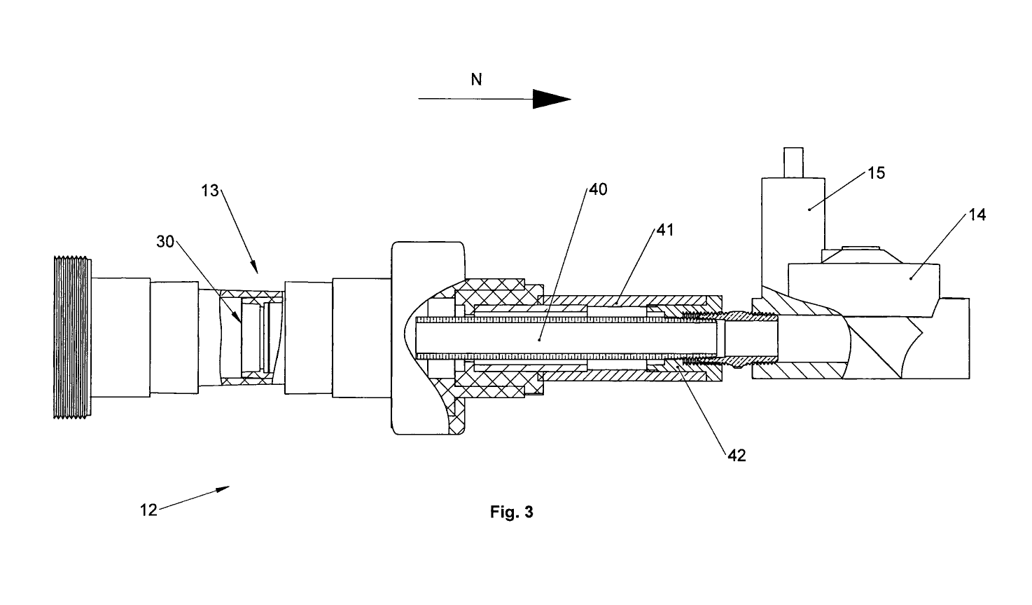

Referring to FIG. 3, there is illustrated an embodiment of the filtering assembly, with the filter 13, the fluid source 14 and the valve 15 shown in greater detail. The filter 13 is part of the components of the pipe network 12 through which water will flow in the normal flow. The fluid source 14 and the valve 15 branch off from the components of normal flow, and are typically operated when the microbubble-producing cycle is off, in a backwash cycle. The valve 15 may be a solenoid valve or any other valve operated to selectively allow the fluid source 14 to direct fluid on the filter 13, in a reverse flow direction in comparison to the normal flow direction, i.e., toward the inlet 11A. Hence, cleaning fluid with dislodge residue from the filter 13 toward the inlet 11A. The fluid source may be any appropriate source, such as the main water line that injects water in the tub commanded by the valve 15 to create a backwash on the filter 13. The reverse flow configuration is one of different options that are possible, another one consisting of directing backwash fluid with residue to the drain. Alternatively, a filter 13 may be provided in close proximity to the inlet 11A, to allow manual removal of the filter 13 for cleaning, when the microbubble-producing cycle is off.

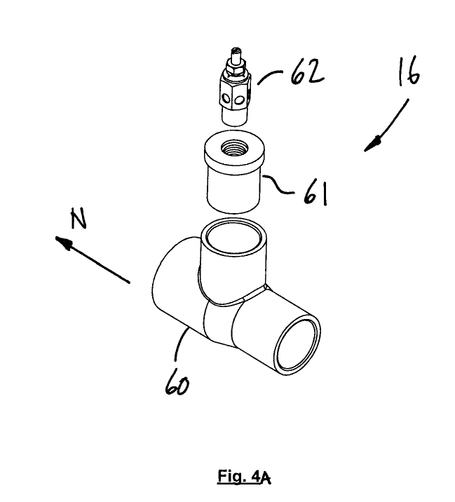

The filter 13 is shown having a screen 30. The normal flow direction is indicated as N in FIG. 3. The fluid source 14 comprises an injection nipple 40 that points toward the screen 30 but is located downstream therefrom. The nipple 40 is concentrically located in a laid T-pipe 41 also shown in FIGS. 2 and 4, which T-pipe 41 is part of the network 12. During the microbubble-producing cycle, fluid will circulate through the screen 30, past the nipple 40 and into the branch portion of the T-pipe section 41 downstream relative to the normal flow direction. A bushing 42 holds the nipple 40 in the position shown in FIG. 3 and in relation with the solenoid valve 15. This is one possible arrangement among others. The arrangement is convenient in that it may be disassembled, for instance to change the screen 30. However, the filtering assembly of FIG. 3 is well suited to be operated autonomously for numerous cycles due to its robustness and simplicity, and because of the backwash cycles operated periodically, such as after each microbubble-producing cycle. It helps in preventing contaminants and solid residue from reaching further components of the microbubble system 10.

Referring to FIG. 4A, the venturi unit 16 is shown in greater detail. The venturi unit 16 is connected to the T-pipe section 41 described previously for the filtering assembly, and is downstream of the filtering assembly, although the venturi unit 16 could be upstream as well. The venturi unit 16 has another T-pipe-like section 60 which is a venturi pipe section with a bushing 61 connected to the perpendicular branch of the venturi pipe section 60. It is observed that a diameter of the perpendicular branch of the venturi pipe section 60 has a smaller internal size than that of the main section of the venturi pipe section 60. A bushing 61 may be used to support a pneumatic muffler 62, or equivalent air control valve. The pneumatic muffler 62 is open to the environment, whereby the negative pressure differential in the perpendicular branch of the venturi pipe section 60, resulting from the venturi effect caused by the flow of liquid in the main section of the venturi pipe section 60, will result in air entering the venturi unit 16 via the pneumatic muffler 62, to mix with the liquid circulating in the venturi unit 16. The pneumatic muffler 62 or equivalent valve will ensure that a suitable amount of air enters the venturi unit 16, for instance to avoid pump cavitation. Needle valves, check valves, spring-loaded valves could be used as alternatives to the pneumatic muffler 62. Likewise, actuated devices like gas injection pumps, etc, could be used as well.

Referring to FIG. 4B, another configuration is shown, in which a gas injection unit is also present. A barbed fitting 62′ is mounted to the bushing 61, and is connected to tubing 63 (including the two small tubing sections shown in FIG. 4B), which may include an inline needle valve 64A allowing air entry (i.e., in equivalent fashion to the pneumatic muffler 62 operating with the venturi effect) and/or an inline filter 64B to receive pressurized gas (e.g., air, oxygen-rich air, ozone) from gas injection unit, such as gas pump 65 (e.g., for instance, an ozonator used in off cycles to clean the system), in one of numerous possible arrangements. The gas pump 65, whether it is an ozonator, a gas source, an air source, etc, may also be replaced by an aromatherapy gas pump that adds scents (e.g., essential oil vapors) to the gas pumped into the tubing 63. The tubing 63 is a convenient and practical solution to interconnect the gas pump 65 to the T-pipe 60. However, other options are considered as well. For instance, rigid pipes may be used for this purpose. Likewise, the assembly of bushing 61, barbed fitting 62′, tubing 63, valve 64A and filter 64B is one of numerous combinations possible to connect the gas pump 65 to the pipe network 12.

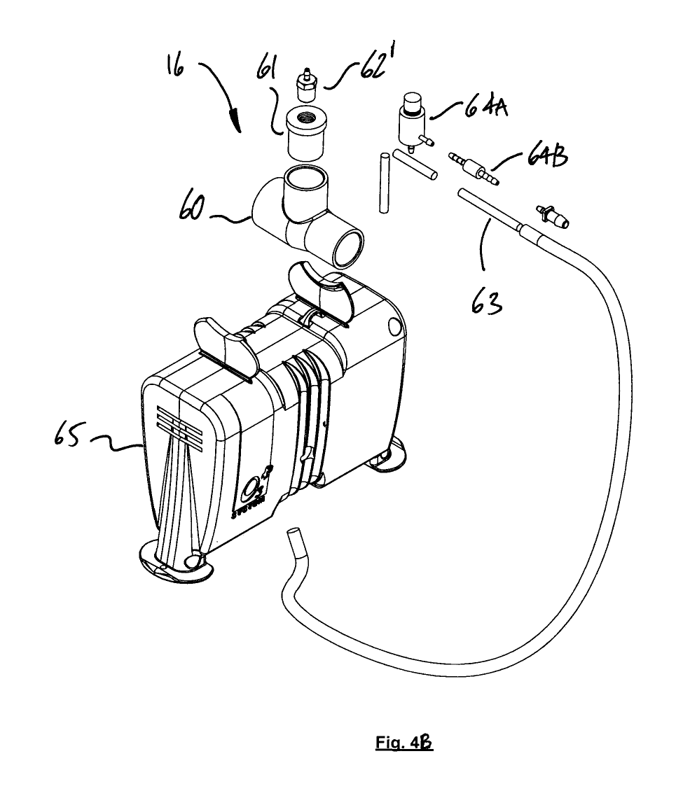

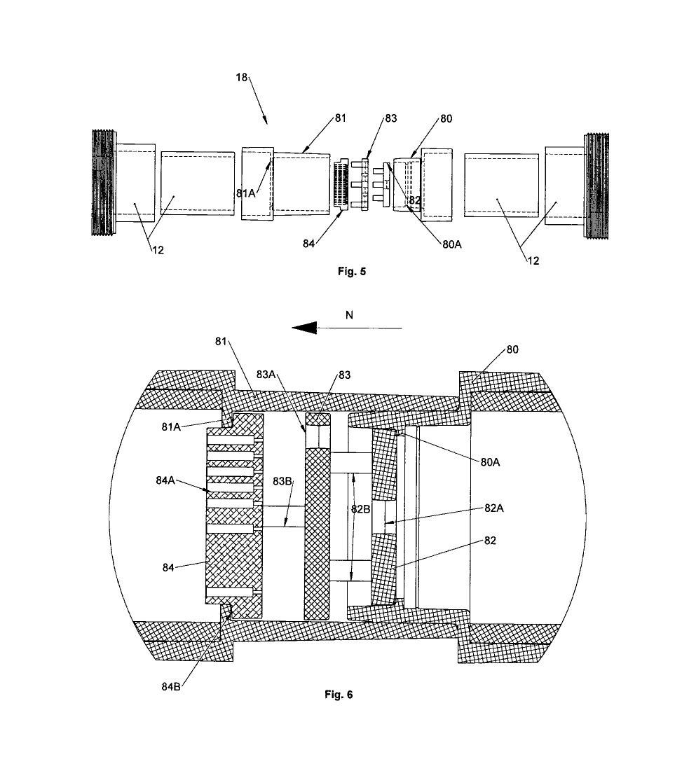

Referring to FIGS. 5 and 6, the microbubble device 18 is shown in greater detail. In the illustrated embodiment, multiple pipe sections are present in the microbubble device 18 so as to form a cartridge-like configuration that may be replaced and disassembled. For instance, the microbubble device 18 may be disassembled without tools. However, the various pipe sections illustrated are one among numerous possibilities. The normal flow direction is shown as N to show a direction of flow of fluids in the microbubble device 18 during the microbubble-producing cycle. The microbubble device 18 has a pipe section 80 that has an internal rim 80A projecting radially in its inner cavity. The pipe section 80 is received in pipe section 81 of greater diameter, for instance by complementary threading and tapping on the pipe sections 80 and 81. The pipe section 81 also has an inwardly-projecting rim 81A. Accordingly, the pair of rims 80A and 81A are used concurrently as abutments to hold captive three different disks in the microbubble device 18. More specifically, there is provided sequentially a converging disk 82, an aerator disk 83 and a reduction disk 84. The pair of rims 80A and 81A is one of numerous configurations that may be used to keep the disks 82, 83, and 84 captive in the arrangement of FIG. 6. The expression disk is used for disks 82, 83, and 84, as the microbubble device 18 has a generally round section. It is however contemplated to have geometries other than round for the microbubble device 18 (e.g., square, oval, polygonal, etc), in which case the disks 82, 83 and 84 could be described as plates, walls, partitions, or the like. However, for simplicity, the expression disk will be used hereinafter, although it encompasses other configurations and shapes.

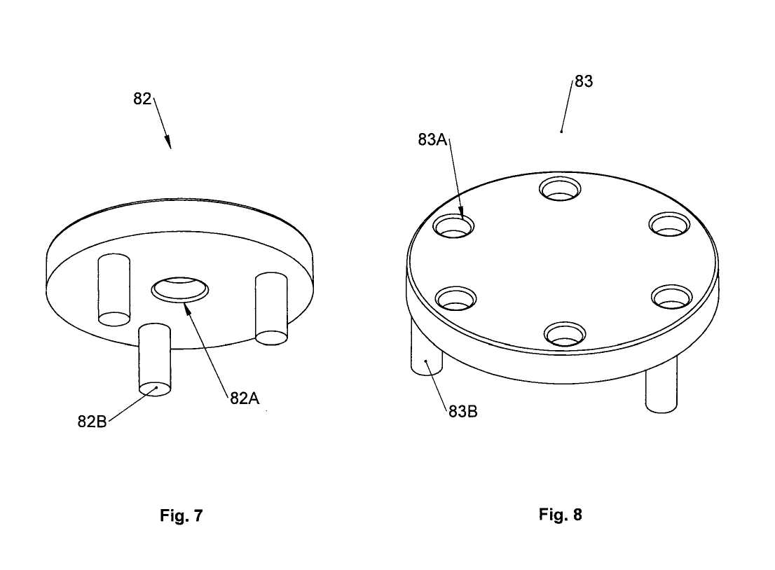

Referring concurrently to FIGS. 6, 7 and 8 the converging disk 82 is seated against the rim 80A, and hence blocks the inner passage defined by the pipe section 80. The converging disk 82 has a central converging passage 82A through which fluid must pass to flow downstream of the converging disk 82. The passage 82A is defined as central, as it may be concentrically defined in the converging disk 82A, but may be eccentrically positioned in the disk 82. In an embodiment, the passage 82A is spaced from the periphery of the disk 82, as it is required that the passage 82A be below a top surface of the water in the pipe section 80 (if any top surface). The passage 82A is the single opening in the converging disk 82 in FIG. 7. It is however considered to have more than one of the passage 82A in the converging disk 82. However, the passages, if there are more than one, are again positioned in the converging disk 82 so as to be below the top surface of water in the pipe section 80. Spacers 82B project axially from the converging disk 82. The spacers 82B are specifically sized to keep the aerator disk 83 at a given distance from the converging disk 82.

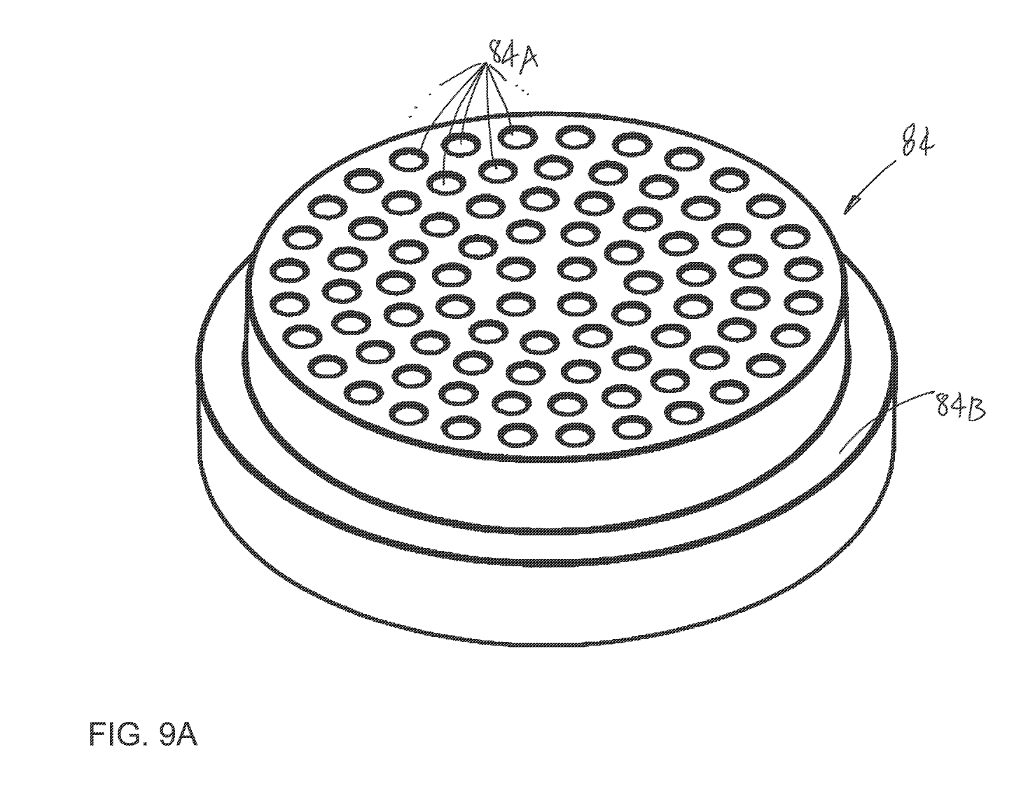

Referring to FIGS. 6 and 8, the aerator disk 83 also blocks the inner passage defined by the pipe section 80. The aerator disk 83 has a plurality of peripheral passages 83A. As shown, the peripheral passages 83A are circumferentially distributed adjacent to the periphery of the aerator disk 83. In similar fashion to the converging disk 82, the aerator disk 83 has spacers 83B projecting axially therefrom to maintain the reduction disk 84 at a predetermined distance from the aerator disk 83. Due to the size of the spacers 82B and 83B, and the thickness of the various disks 82 to 84 as well as the spacing between the rims 80A and 81A, the spatial arrangement of disks as in FIG. 6 is maintained in spite of the fluid pressures to which the disks 82 to 84 are exposed. Other configurations are considered as well, such as annular spacers, additional rims, etc. The above-described configuration is simple in that the disks 82 to 84 are essentially stacked against one another to preserve the desired spacing.

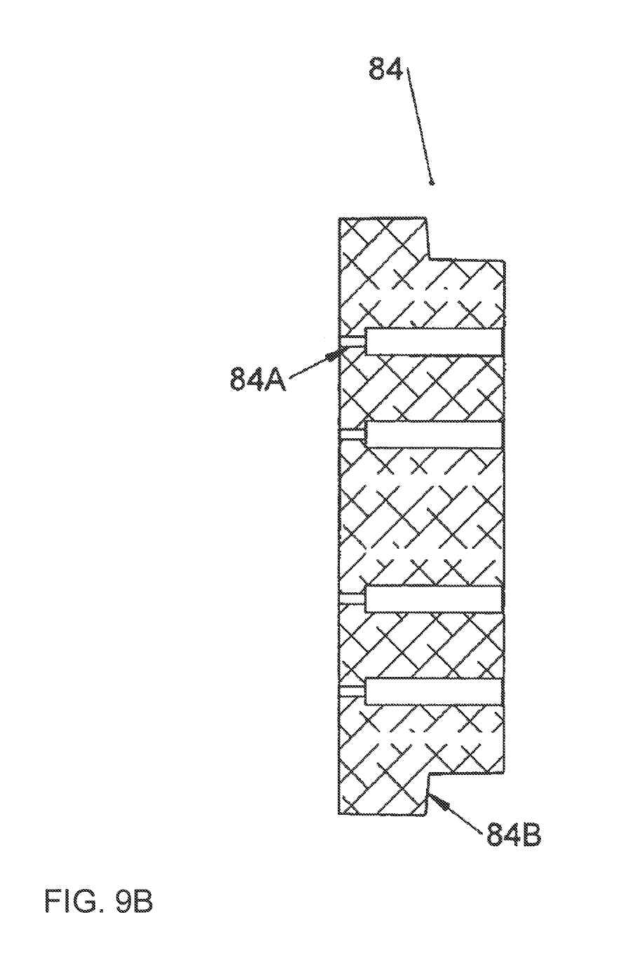

Referring to FIGS. 6, 9A and 9B, the reduction disk 84 also blocks the inner passage defined by the pipe section 80. The reduction disk 84 has a plurality of passages 84A. Unlike the disks 82 and 83, the passages 84A in the reduction disk 84 are distributed all over the surface of the reduction disk 84. The passages 84A are shown as having a substantial increase in diameter along the normal flow direction N, at some point into the reduction disk 84. Stated differently, the passages 84A have a first narrower upstream section, and a second wider downstream section. The first narrower upstream section acts as a throat for the gas/liquid mixture entering the passages 84A of the reduction disk 84. In the illustrated embodiment, this is done by way of a counterbore arrangement, although other configurations are considered, such as countersink, flaring, etc. The reduction disk 84 has a shoulder 84B by which the reduction disk 84 will abut against the rim 81A. This is best shown in FIG. 6, and is one of different arrangements possible.

According to a non-limitative embodiment, exemplary diameters for the passages 84A of the reduction disk 84 are 0.026 in for the narrower upstream section (long of 0.070 in+/−0.020 in), and 0.070 for the wider downstream section, giving a ratio of about 2.7. The narrower upstream section is a throat that is smaller than 0.039 in, i.e., the microbubble-size threshold. However, some tolerance is possible for the diameters of the passages 84A, and thus a variation in ratio is possible, for instance with a range of ratios between 2.4 and 3.0. In terms of thickness, the disk 84 may be 0.43 inch thick+/−0.1 inch for example (a ratio of 16.5 thickness to throat diameter, +/−1.5), with an upstream diameter of about 1.55 inch, and a downstream diameter of 1.33 inch. The thickness of the disk 84 is greater than a microbubble size, whereby the passages 84A have an elongated shape. To maintain the pressure upstream of the reduction disk 84, there is a limited number of the passages 84A in the reduction disk 84. For instance, there may be fewer than 90 passages 84A for the diameter of 1.55 inch. A suitable range is between 40 and 90 passages 84A.

The passages 82A and 83A are wider than the passages 84A, as they are not provided to output microbubbles, unlike the passages 84A in the reduction disk 84. For example, the passage 82A in the converging disk 82 may have a diameter ranging between 0.2 to 0.5 inch, while the passages 83A in the aerator disk 83 may each have a diameter between 0.16 and 0.18 inch.

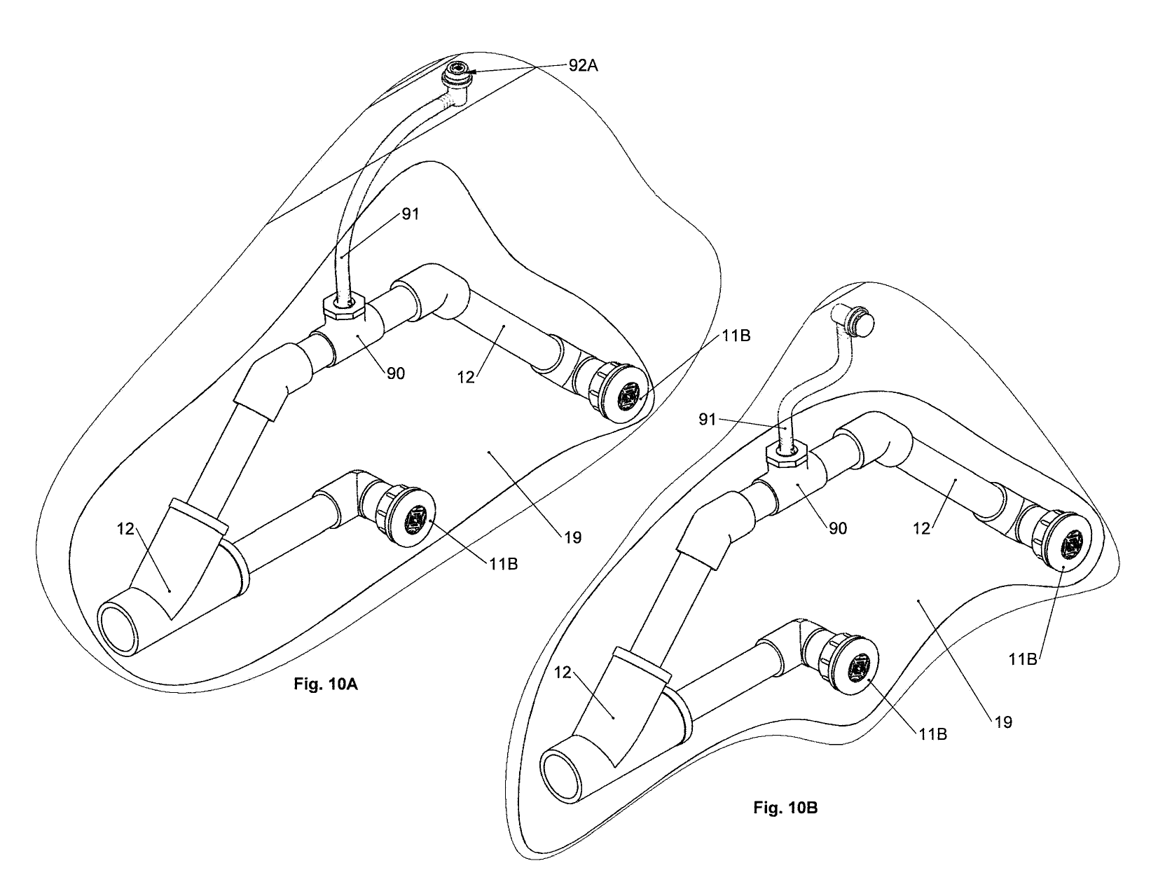

Referring to FIGS. 10A and 10B, different vent unit configurations are shown. In both embodiments, there is provided a T-pipe section 90, from which projects a tubing 91 or like pipe that will reach a check valve 92A in FIG. 10A and a vent 92B in the FIG. 10B. In the case of the check valve 92A, the check valve 92A is provided on a top wall surface of the tub A. The check valve 92A is of the type that will prevent water from passing therethrough but allow air exhaust. On the other hand, the vent 92B of FIG. 10B is on a vertical wall of the tub A, whereby it does not require a check valve mechanism to prevent water from exhausting therethrough, as water overflowing through the vent 92B would flow down into the tub A. The T-pipe section 90 may be located in a raised section of the piping network 12, to maximize the amount of gas that is exhausted by the vent configuration.

Now that the various components of the microbubble system 10 have been described, an operation thereof will be set forth. The microbubble system 10 should only be operated when there is liquid in the tub A, above a given level, i.e., above the inlet 11A. Accordingly, the microbubble system 10 may have level sensors to ensure that there is an adequate level of water in the tub. During operation, the pump 17 is operated to induce fluid flow in the pipe network 12 from the inlet 11A to the outlets 11B, to operate the microbubble-producing cycle. In the microbubble-producing cycle, water from the tub A entering the system 10 through the inlet 11A will pass through the filter 13 for solid residue to be removed, and move downstream through the microbubble device 18 and back into the tub via the outlets 11B. In alternative embodiments, the water may be obtained from a water source, such as the main water line.

The venturi unit 16 allows gas to be drawn into the flow of water in the pipe network 12. Alternatively, or supplementally, the gas injection unit 65 is activated in the microbubble-producing cycle, to inject gas in the flow of water in the pipe network 12. Any timing unit may be used in conjunction with the gas injection unit 65 to control the amount of gas that is injected, to reach adequate gas content in the water, e.g., gas saturation levels. The resulting mixture of liquid and gas is passed through the pump 17, which pump 17 will perform some additional gas/liquid mixing by its propelling action.

Upon entering the microbubble device 18, the gas and liquid will further mix as they are forced through the passage 82A of the converging disk 82. As the passage 82A is below the top surface of water, gas will be forced downwardly through the passage 82A as gas would have otherwise tend to remain on the surface of the water. Hence, for gas to pass through the passage 82A, it may have to mix with water.

The gas/water mixture is then passed through the aerator disk 83 and more specifically through the peripheral passages 83A thereof. The circumferential arrangement of the passages 83A, and the diameter of the passages 83A, may cause the formation of bubbles of non-microbubble size in the water and/or may further mix air and gas.

The bubbles and/or air/gas mixture in the water resulting from the effect of the aerator disk 83 reach the reduction disk 84. By passing through the passages 84A of the reduction disk 84, the bubbles will be broken down due to the relatively small diameters of the passages 84A. The subsequent increase in diameter of the passages 84A will result in reduction of the velocity of the gas/water mixture and in a pressure drop. This in turn will cause the creation of the microbubbles in the water, which microbubble and water will be projected into the tub A by the outlets 11B.

In order for microbubbles to be generated, the pump 17 must provide sufficient liquid pressure to cause microbubble formation at the reduction disk 84. For example, with the dimensions of the passages 84A described above, the pump 17 may be required to create a pressure at the reduction disk 84 above 10 Psi, for instance in a range between 10 Psi and 52 Psi. In a particular embodiment, a pressure range of 18 to 38 Psi results in microbubbles of preferable quality and quantity. Lower pressures may be suitable for creating microbubbles, but at a slower rate. Moreover, the presence or absence of the gas pump 65 may have an impact on the pressure generated by the pump 17, whereby this factor is to be taken into consideration when sizing the pump 17.

In the event that a backwash is to be performed, the venturi unit 16 and pump 17 are stopped and fluid is injected by operation of the valve 15 through the filter 13. Therefore, residue will be flowed back into the tub via the inlet 11A.

The sizing (e.g., diameter and length) of the various disks 82 to 84 is essential in creating the microbubbles effectively.

1. A microbubble device for creating microbubbles in a tub, the microbubble device comprising:
at least one pipe section defining an inner passage for flow of fluids in a longitudinal direction;
at least a first mixing member transversely positioned inside the inner passage to block same, the first mixing member defining at least one passage longitudinally oriented and adapted to be below a top liquid surface circulating in the inner passage, the at least one passage being larger than microbubbles;
a reduction member transversely positioned inside the inner passage to block same, the reduction member spaced apart and downstream of the first mixing member, the reduction member defining a plurality of longitudinally oriented passages each having a microbubble-size throat.

2. The microbubble device according to claim 1, further comprising a second mixing member transversely positioned inside the inner passage to block same, the second mixing member being positioned between the first mixing member and the reduction member and spaced apart therefrom, the second mixing member defining a plurality of circumferentially distributed passages being larger than microbubbles.

3. The microbubble device according to claim 1, wherein the at least one pipe section has a rim projecting into the inner passage, the reduction member being held captive in abutment against the rim.

4. The microbubble device according to claim 3, wherein the at least one pipe section includes two pipe sections assembled to one another, with an upstream one of the pipe sections having an abutment holding the first mixing member captive and spaced apart from the reduction member with a spacer therebetween.

5. The microbubble device according to claim 4, wherein the spacer is at least one arm monolithically part of the first mixing member.

6. The microbubble device according to claim 1, wherein the first mixing member has a single one of the passage, the single passage being centrally located in the first mixing member.

7. The microbubble device according to claim 1, wherein the plurality of longitudinally oriented passages each have an upstream straight cylindrical portion forming said throat, and a downstream straight cylindrical portion of greater diameter than microbubble size.

8. The microbubble device according to claim 1, wherein the at least one pipe section has a round section, and further wherein the at least first mixing member and the reduction member are disks.

9. A microbubble system comprising:
at least one pipe network defining an inner passage for flow of fluids in a longitudinal direction, the pipe network adapted to receive at least one fluid and having an outlet connected to a tub for outputting the at least one fluid into the tub;
a pump in the pipe network for inducing a flow of the at least one fluid into the tub;
at least one gas intake in the pipe network or in the pump configured for inletting gas into the flow of the at least one fluid into the tub; and
a reduction member transversely positioned inside the inner passage to block same, the reduction member downstream of the pump, the reduction member defining a plurality of longitudinally oriented passages each having a microbubble-size throat.

10. The microbubble system according to claim 9, further comprising at least a first mixing member transversely positioned inside the inner passage to block same, the first mixing member being downstream of the pump and upstream of the reduction member and defining at least one passage longitudinally oriented and adapted to be below a top liquid surface circulating in the inner passage, the at least one passage being larger than microbubbles.

11. The microbubble system according to claim 10, further comprising a second mixing member transversely positioned inside the inner passage to block same, the second mixing member being positioned between the first mixing member and the reduction member and spaced apart therefrom, the second mixing member defining a plurality of circumferentially distributed passages being larger than microbubbles.

12. The microbubble system according to claim 11, wherein the first mixing member, the second mixing member and the reduction member are held captive between a pair of abutments inside the pipe network, with spacers between the members.

13. The microbubble system according to claim 12, wherein the spacers are arm monolithically part of at least one of the first mixing member, the second mixing member and the reduction member.

14. The microbubble system according to claim 9, wherein the plurality of longitudinally oriented passages in the reduction member each have an upstream straight cylindrical portion forming said throat, and a downstream straight cylindrical portion of greater diameter than microbubble size.

15. The microbubble system according to claim 9, wherein the at least one gas intake is a venturi unit having a gas inlet tube projecting radially upward from a pipe section of the pipe network.

16. The microbubble system according to claim 15, comprising a flow controlling device in the gas inlet tube.

17. The microbubble system according to claim 15, wherein the venturi unit is upstream of the pump.

18. The microbubble system according to claim 9, wherein the at least one gas intake comprises a gas pump.

19. The microbubble system according to claim 15, wherein the pipe network has an inlet connected to the tub to receive liquid the at least one fluid from the tub.

20. The microbubble system according to claim 9, further comprising a vent tube projecting upwardly from the pipe network downstream of the reduction member and connected to a wall of the tube to exhaust air in the pipe network.
